(19) United States
(12) Patent Application Publication
(10) Pub. No.: US 2012/0296466 A1
(43) Pub. Date: Nov. 22, 2012

(54) CONTROL METHOD FOR THE CASTING LEVEL OF A CONTINUOUS CASTING MOLD

(76) Inventor: Bernhard Weisshaar, Herzogenaurach (DE)

(21) Appl. No.: 13/522,457

(22) PCT Filed: Dec. 28, 2010
(86) PCT No.: PCT/EP2010/070769

§ 371 Date: Jul. 16, 2012

(30) Foreign Application Priority Data
Jan. 15, 2010 (EP) 10150817.4

(51) Int. Cl. G05D 5/00

(52) U.S. Cl. 700/146

(57) ABSTRACT

A method is provided for adjusting the inflow of liquid metal into a continuous casting mold using a closing device. The partially solidified metal strand is drawn out of the continuous casting mold. A measured actual value of the casting level is fed into a casting level controller, which derives a target setting for the closing device. The measured actual value and a target setting of the closing device are fed to an interference compensator, which determines an expected value for the casting level, which is subtracted from the measured actual value. The difference is fed to a differential controller that derives a controller output signal therefrom, which is multiplied by a superposition factor and superimposed on the target setting as an interference compensation value. An inflow signal derived from the actual setting is further superimposed on the controller output signal and fed to an integrator, which generates an output signal corresponding to the expected value for the casting level.

### CROSS-REFERENCE TO RELATED APPLICATIONS

This application is a U.S. National Stage application of International Application No. PCT/EP2010/070769 filed Dec. 28, 2010, which designates the United States of America, and claims priority to EP Patent Application No. 10150817.4 filed Jan. 15, 2010. The contents of which are hereby incorporated by reference in their entirety.

### TECHNICAL FIELD

The present disclosure relates to a control method for the casting level of a continuous casting mold, wherein the inflow of liquid metal into the continuous casting mold is adjusted by means of a closing facility and the partially solidified metal strand is drawn out of the continuous casting mold by means of a draw facility, wherein a measured actual value of the casting level is fed into a casting level controller, said controller determining a target setting for the closing facility on the basis of the actual value and feeding the closing facility, wherein the measured actual value and an actual setting of the closing facility are fed to an interference compensator, and wherein an expected value for the casting level is determined within the interference compensator and is subtracted from the measured actual value of the casting level.

The present disclosure also relates to a computer program, which includes a machine code, which can be executed by a control facility for a continuous casting system, to such a control facility for a continuous casting system, and to a continuous casting system controlled by such a control facility.

### BACKGROUND

The casting level in the continuous casting mold is inter alia undesirably influenced by sudden interferences. Examples of such undesirable interferences are the so-called “clogging” and “unclogging”, in other words the sudden adhesion or decay of aluminum oxide in the inlet channel of the mold. Similarly the casting level can be undesirably influenced by a rearward drawing of the metal strand. Each interference in the casting level signifies a loss of quality of the strand. Casting level fluctuations are therefore to be kept as minimal as possible.

In the prior art, the casting level controller is in most cases embodied as a PI controller or as a PID controller, which also has several additional functions for combating specific interferences. One example of an additional function of this type is the compensation for bulging oscillations by an oscillation compensator, e.g., as described in U.S. Pat. No. 5,921,313 A.

The integral contribution of the casting level controller is needed in the prior art, in order to find and retain the stationary target setting for the closing facility.

With sudden inflow interferences or drawing interferences, the casting level controller must react quickly. In particular, the integral contribution of the casting level controller must become rapidly attuned to a new target setting for the closing facility. An integral contribution with a small reset time will however respond quickly but overshoot. An integral contribution with a large reset time will however not overshoot, but responds too slowly. In both instances, the casting level cannot be restored to its target value with the required speed and nevertheless in a reliably damped fashion.

### SUMMARY

In one embodiment, a control method is provided for the casting level of a continuous casting mold, wherein the inflow of liquid metal into the continuous casting mold is adjusted by means of a closing facility and the partially solidified metal strand is drawn out of the continuous casting mold by means of a draw facility, wherein a measured actual value of the casting level is fed to a casting level controller, which, with the aid of the actual value and a corresponding target value determines a target setting for the closing facility and feeds the same to the closing facility, wherein the measured actual value and an actual setting of the closing facility are fed to an interference compensator, wherein an expected value for the casting level is determined within the interference compensator and is subtracted from the measured actual value of the casting level, wherein the difference within the interference compensator is fed to a difference controller, which determines a controller output signal therefrom, wherein the controller output signal is on the one hand multiplied by a superposition factor and the controller output signal multiplied by the superposition factor is superimposed onto the target setting as an interference compensation value, wherein an inflow signal derived from the actual setting is superimposed onto the controller output signal on the other hand and the superposition result within the interference compensator is fed to an integrator, the output signal of which corresponds to the expected value for the casting level.

In a further embodiment, the expected value for the casting level is subtracted from the measured actual value of the casting level in an undelayed fashion. In a further embodiment, the superposition factor comprises an initial value at the start of the control method and is continuously increased to a final value during the course of the control method. In a further embodiment, the initial value of the superposition factor is zero and the final value of the superposition factor is one. In a further embodiment, the casting level controller is embodied as a controller with integral response and that a reset time of the casting level controller is increased from an initial value to a final value during and/or after increasing the superposition factor. In a further embodiment, the final value of the reset time is infinite. In a further embodiment, the difference controller comprises a proportional amplification and that the proportional amplification is increased from an initial value to a final value during and/or after increasing the superposition factor. In a further embodiment, the initial value of the proportional amplification of the difference controller is equal to a proportional amplification of the casting level controller. In a further embodiment, the difference controller is embodied as a pure P-controller.

In another embodiment, a computer program includes a machine code, which can be executed by a control facility for a continuous casting system and the execution of which by the control facility causes the control facility to control the casting level of a continuous casting mold of the continuous casting system according to a control method as claimed in one of the above claims.

In a further embodiment, the computer program is stored on a data carrier in machine-readable form. In a further embodiment, the data carrier is a component of the control facility. computer program

In another embodiment, a control facility is provided for a continuous casting system, the control facility being embodied such that during operation it executes any of the control methods discussed above. In another embodiment, a continuous casting system controlled by such a control facility is provided.

### BRIEF DESCRIPTION OF THE DRAWINGS

Example embodiments will be explained in more detail below with reference to figures, in which:

FIG. 1 shows a schematic representation of a continuous casting system, according to an example embodiment,

FIG. 2 shows a control-specific block diagram of a control arrangement, according to an example embodiment,

FIG. 3 shows a schematic representation of the internal structure of an interference compensator, according to an example embodiment, and

FIGS. 4 and 5 show example time diagrams, according to an example embodiment.

### DETAILED DESCRIPTION

Some embodiments disclosed herein create possibilities of achieving more precise control in a continuous casting process or system.

Some embodiments provide a control method in which: the difference within the interference compensator is fed to a difference controller, which determines a control output signal therefrom, the controller output signal is on the one hand multiplied by a superposition factor and the controller output signal multiplied by the superposition factor is superimposed on the target setting as an interference compensation value, and an inflow signal derived from the actual setting is further superimposed on the controller output signal, and the superposition result is fed into an integrator within the interference compensator, the output signal thereof corresponds to the expected value for the casting level.

In one embodiment, the expected value for the casting level is immediately subtracted from the measured actual value of the casting level. This procedure achieves a quicker response to casting level interferences.

The superposition factor may have an initial value at the start of the control method and during the course of the control method to be continuously increased to a final value. This procedure may enable an interference-free switching-on of the interference compensator. This may apply very particularly if the initial value of the superposition factor is zero and the final value of the superposition factor is one.

The casting level controller may be embodied as a controller with integral response, for instance as a PI controller or as PID controller. On account of its integral response, the casting level controller has a reset time. The reset time is characteristic of how quickly the casting level controller responds to interferences. In particular, with a small reset time the casting level controller responds quickly to interferences, but has the tendency to overshoot. Conversely, with a long reset time, the casting level controller responds in a stable manner to casting level interferences, but responds more slowly. In one embodiment, the reset time of the casting level controller may be increased from an initial value to a final value during and/or after increasing the superposition factor. The initial value and the final value of the reset time are naturally values other than the initial value and final value of the superposition factor.

It is possible for the final value of the reset time to be finite. In this case, an integral contribution of the casting level controller is retained in each operating state. It is however likewise possible for the final value of the reset time to be infinite. This corresponds to a complete switching-off of the integral contribution of the casting level controller. If the casting level controller is embodied for instance as a PI controller, it still operates as a P controller with an infinite reset time. Similarly, a PID controller can be reduced to a PD controller for instance by increasing the reset time to the infinite value.

The difference controller may be embodied (at least) as a proportional controller. It may therefore comprise a proportional amplification. In one embodiment, the proportional amplification is increased during and/or after increasing the superposition factor from an initial value to a final value. The initial and final value of the proportional amplification are herewith values other than the initial value and the final value of the superposition factor.

Increasing the proportional amplification of the difference controller and increasing the reset time of the casting level controller are independent of one another. It is also possible to increase only the one value and to keep the other value constant or increase both values. In the event that both values are increased, the increase can take place in time frames which differ from one another.

The initial value of the proportional amplification of the difference controller may be determined according to requirements. The initial value may equal to a proportional amplification of the casting level controller.

The difference controller may be embodied for instance as a PI controller or as an even more complex controller. Or, the difference controller may be embodied as a pure P controller.

Some embodiments provide a computer program executable by a control facility to control the casting level of the continuous casting mold by any of the methods disclosed herein. The computer program may be stored for instance on a data carrier in machine-readable form. The data carrier may be a component of the control facility.

Some embodiments provide a control facility for a continuous casting system, which is embodied such that during operation it executes any of the methods disclosed herein. Finally, some embodiments provide a continuous casting system, which may be controlled by such a control facility.

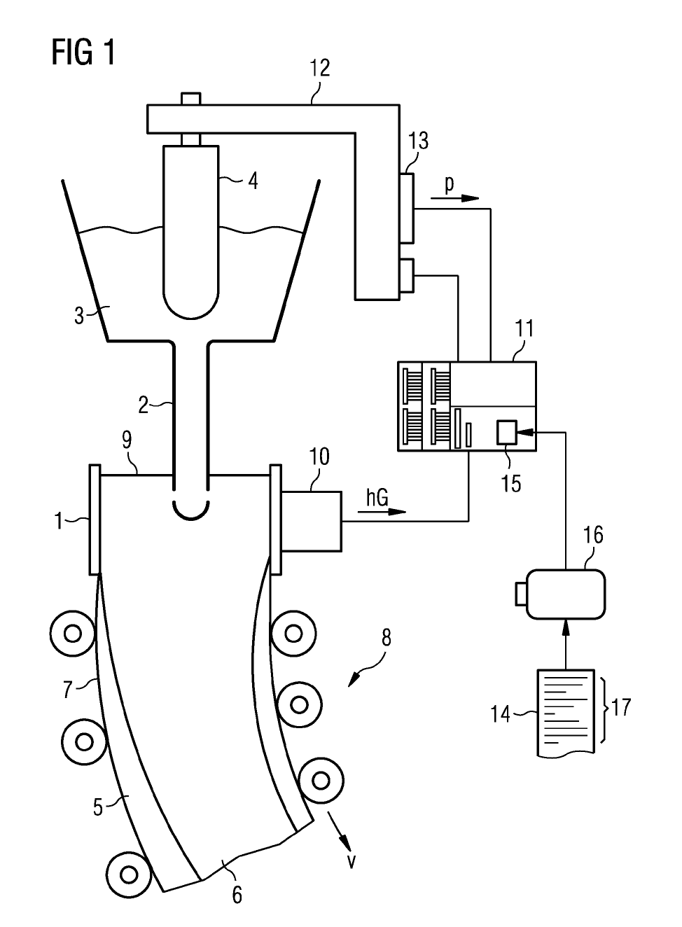

According to FIG. 1, a continuous casting system may comprise a continuous casting mold 1. Liquid metal 3, for instance steel or aluminum, is cast into the continuous casting mold 1 by way of an immersion pipe 2. The inflow of the liquid metal 3 into the continuous casting mold 1 is adjusted by means of a closing facility 4. FIG. 1 shows an embodiment of the closing facility 4 as a closing plug. In this case, a position of the closing facility 4 corresponds to a lifting position of the closing plug. Alternatively, the closing facility 4 can be embodied as a slider. In this case, the closing position corresponds to the slider position.

The liquid metal 3 located in the continuous casting mold 1 is cooled by means of cooling facilities, so that a strand shell 5 forms. The core 6 of the metal strand 7 is however still liquid. It only solidifies later. The cooling facilities are not shown in FIG. 1. The partially solidified metal strand 7 (solidified strand shell 5, liquid core 6) is drawn from the continuous casting mold 1 by means of a drawing facility 8.

The casting level 9 of the liquid metal 3 in the continuous casting mold 1 is to be kept as constant as possible. A drawing speed v, at which the partially solidified metal strand 7 is drawn from the continuous casting mold 1, is generally constant. Therefore, the position of the closing device 4 may be traced in order to adjust the inflow of the liquid metal 3 into the continuous casting mold 1 such that the casting level 9 is kept as constant as possible.

An actual value hG of the casting level 9 is registered by means of a corresponding measuring facility 10 (known as such). The actual value hG is fed to a control facility 11 for the continuous casting system. In accordance with a control method which is described in more detail below, the control facility 11 determines a target setting p* which is to be assumed by the closing facility 4. The closing facility 4 is then activated accordingly by the control facility 11. The control facility 11 generally outputs a corresponding control signal to an adjustment facility 12 for the closing facility 4. The adjusting facility 12 can be a hydraulic cylinder unit for instance.

An actual position p of the closing facility 4 is generally also registered by means of a corresponding measuring facility 13 (known as such) and fed to the control facility 11. Control (closed loop control) of the closing position therefore generally takes place. Alternatively, a pure control (open loop control) would also be possible.

The control facility 11 is embodied such that during operation it executes a control method as disclosed herein. The mode of operation of the control facility 11 is generally determined by a computer program 14, with which the control facility 11 is programmed. To this end, the computer program 14 within the control facility 11 is stored in a data carrier 15, for instance a Flash EPROM. The data carrier 15 is a component of the control facility 11. Storage takes place in machine-readable form.

The computer program 14 may have been fed to the control facility 11 by way of a mobile data carrier 16, for instance a USB memory stick (shown) or an SD storage card (not shown). The computer program 14 is also stored on the mobile data carrier 16 in machine-readable form. Alternatively, it is possible to feed the computer program 14 into the control facility 11 by way of a computer network connection or a programming facility.

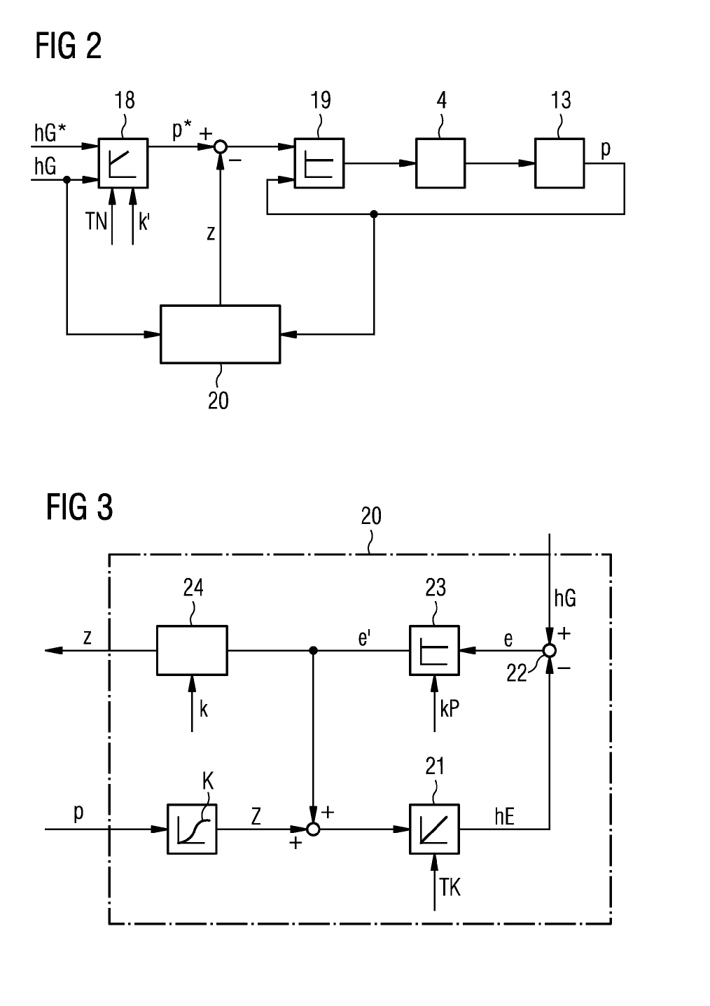

The computer program 14 includes a machine code 17, which can be immediately executed by the control facility 11. Execution of the machine code 17 by means of the control facility 11 means that the control facility 11 controls the casting level 9 of the continuous casting mold 1 in accordance with a control method as disclosed herein. This control method is subsequently explained in more detail in conjunction with FIGS. 2 and 3.

FIG. 2 shows a control arrangement implemented by the control facility 11. Operation of the control arrangement in FIG. 2 provides for a control method for the casting level 9 of the continuous casting mold 1.

According to FIG. 2, the control arrangement comprises a casting level controller 18. The casting level controller 18 determines the target setting p* for the closing facility 4 with the aid of a target value hG* for the casting level 9 and of the actual value hG registered by means of the measuring facility 10 for the casting level 9. The controller characteristic of the casting level controller 18 is proportionally integral in accordance with the representation in FIG. 2. Alternatively, other control characteristics are also possible, for instance PID. Irrespective of its concrete embodiment, the casting level controller 18 however may be embodied as a controller with an integral response.

The target setting p* for the closing facility 4 is fed to the closing facility 4. As already mentioned, the adjustment of the closing facility 4 is usually controlled. In this case, which is shown in FIG. 2, the target setting is fed to a position controller 19, to which the actual position p of the closing facility 4 is also fed. The position controller 19 can also be embodied as a P controller.

The actual position p of the closing facility 4 acts on the actual casting level 9 on account of the inflow of liquid metal 3 adjusted thereby. The actual value hG of the casting level 9 is registered and, as already mentioned, fed to the casting level controller 18.

Interferences can act on the continuous casting mold 1, which influence the casting level 9. An interference compensator 20 is provided to compensate for the interferences. The measured actual value hG of the casting level 9 and the actual setting p of the closing facility 4 are fed to the interference compensator 20.

The structure and mode of operation of the interference compensator 20 are subsequently explained in more detail below in conjunction with FIG. 3.

According to FIG. 3, the interference compensator 20 includes inter alia an integrator 21. An integration time constant TK of the integrator 21 may be determined by the cross-section of the continuous casting mold 1, the measuring range δhG of the measuring facility 10 for the actual value hG of the casting level 9 and the measuring range δp of the measuring facility 13 for the actual position p and the characteristic curve K of the closing facility 4. In particular, the integration time constant TK can be determined at

$$TK = \frac{δ hG}{δ p} \cdot K$$

The concrete value for the characteristic curve K results from a fictitious working point of the closing facility 4, in other words the position of the closing facility 4 in which the inflow of liquid metal 3 into the continuous casting mold 1 and the quantity of metal drawn with the given draw speed v are equal.

An input value 21 is fed to the integrator 21 within the interference compensator 20, this being explained again later. By integrating the input value according to the integration time constant TK, the integrator 21 determines an output signal hE.

The output signal hE corresponds to an expected value hE for the casting level 9.

The expected value hE is fed to a node point 22 within the interference compensator 20, to which the actual value hG of the casting level 9 is also fed. The expected value hE is subtracted from the actual value hG in the node point 22. The difference is subsequently referred to with reference character e.

The measuring facility 10 for the casting level 9 is delayed. The actual value hG of the casting level 9 therefore features a delay time. It is possible to actively delay the expected value hE by a delay element accordingly. Thus, in some embodiments, the delay element is arranged between the integrator 21 and the node point 22. In some embodiments, no delay element of this type is present. The expected value hE for the casting level 9 may therefore be subtracted from the measured actual value hG of the casting level 9 in an undelayed fashion.

The difference e is fed to a difference controller 23 within the interference compensator 20. The difference controller 23 determines a controller output signal e′ with the aid of the difference e. The difference controller 23 can be embodied according to requirements. For instance, the difference controller 23 can be embodied as a PI controller. The difference controller 23 may be embodied as a pure P controller. Irrespective of its concrete embodiment, the difference controller 23 nevertheless comprises a proportional amplification kP.

In terms of approach the controller output signal e′ already corresponds to an interference compensation value z, which is to be superimposed onto the target setting p* of the closing facility 4. Prior to superimposition, the controller output signal e′ is however multiplied by a superposition factor k in a multiplier 24. The product comprising superposition factor k and controller output signal e′ corresponds to the interference compensation value z.

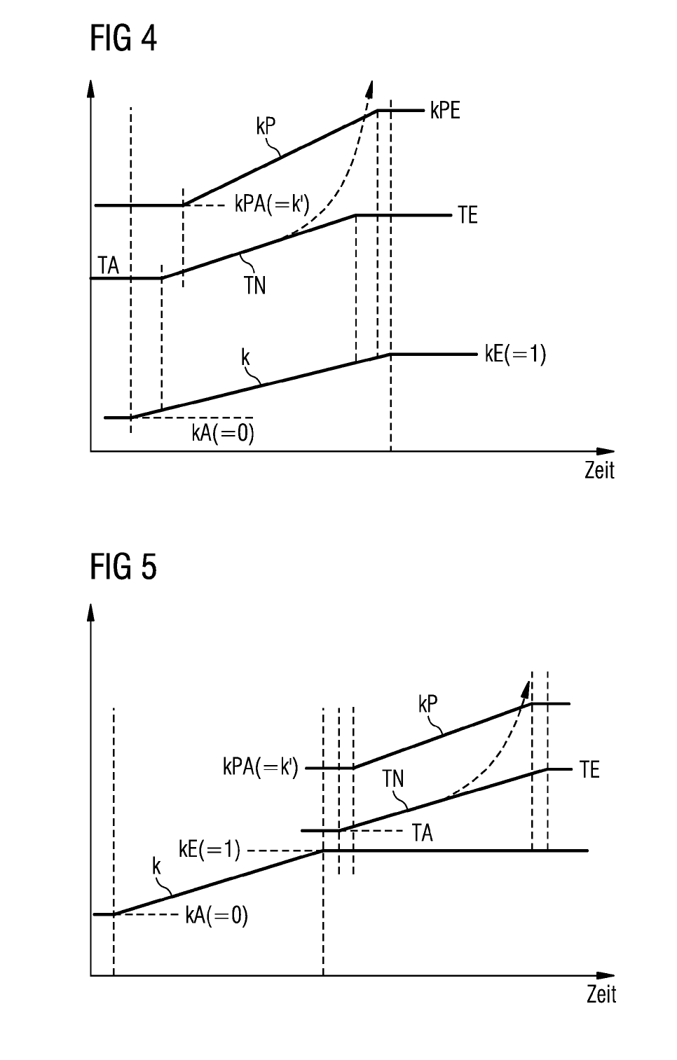

The superposition factor k may comprise a fixed value. It is possible in particular for the superposition factor k to constantly have the value one. However the superposition factor k may comprise an initial value kA according to the representation in FIG. 4 at the start of the control method and to be constantly increased to a final value kE during the course of the control method. It is particularly possible for the initial value kA to be zero and the final value kE to be one.

An inflow signal Z is also superimposed on the controller output signal e′ within the interference compensator 20. The inflow signal Z is derived from the actual setting p of the closing facility 4 in accordance with FIG. 3. In particular, the inflow signal Z can be determined in accordance with FIG. 3 such that with the aid of the actual position p of the closing facility 4 and the characteristic curve K of the closing facility 4, the inflow Z is determined, which results with the given actual position p of the closing facility 4. Within the interference compensator 20 the superposition result is fed to the integrator 21 as its input signal.

As already mentioned, the casting level controller 18 may be embodied as a controller with integral response. The casting level controller 18 may therefore comprise a reset time TN. The reset time TN is characteristic of the integral response of the casting level controller 18.

It is possible for the reset time TN of the casting level controller 18 to be kept temporally constant. According to the display in FIGS. 4 and 5, however the reset time TN of the casting level controller 18 may be increased after increasing the superposition factor k from an initial value TA to a final value TE. FIG. 4 shows an increase in the reset time TN during the increase in the superposition factor k. FIG. 5 shows an increase in the reset time TN after increasing the superposition factor k. Other embodiments are also possible. For instance, increasing the reset time TN can be started by increasing the superposition factor k, and can be retained throughout the point in time at which the superposition factor k reaches its final value kR. Similarly, it is possible to begin with increasing the reset time TN at a point in time at which the superposition factor k is already greater than its initial value kA, but still smaller than its final value kE.

According to the continuous representation in FIGS. 4 and 5, it is possible for the final value TE of the reset time TN to be finite. In this case, after reaching the final value TE of the reset time TN, an integral response of the casting level controller 18, even if reduced, is retained. Alternatively, it is possible according to the dashed representation in FIGS. 4 and 5 to infinitely increase the reset time TN to the final value TE. In this case, the integral response of the casting level controller 18 is completely suppressed.

It is similarly possible for the proportional amplification kP of the difference controller 23 to be constant during the entire control method. However, according to the representations in FIGS. 4 and 5, the proportional amplification kP during (see FIG. 4) and/or after (see FIG. 5) the increase in the superposition factor k may be increased from an initial value kPA to a final value kPE. Similarly to increasing the reset time TN, embodiments are also possible here such that increasing the proportional amplification kP of the difference controller 23 is begun together with increasing the superposition factor k, but extends beyond the point in time at which the superposition factor k reaches its final value kE. It is similarly possible to begin with increasing the proportional amplification kP of the difference controller 23 for instance, whereas the superposition factor k has an intermediate value between its initial value kA and its final value kE.

The initial value kPA of the proportional amplification kP of the difference controller 23 can be selected according to requirements. The initial value kPA may equate to a proportional amplification k′ of the casting level controller 18.

Increasing the proportional amplification kP of the difference controller 23 and increasing the reset time TN of the casting level controller 18 can be realized independently of one another. In particular, it is possible to increase only the proportional amplification kP of the difference controller 23, which by contrast keeps the reset time TN of the casting level controller 18 constant. Similarly, it is conversely possible to only increase the reset time TN of the casting level controller 18, and to keep the proportional amplification kP of the difference controller 23 constant. However both the proportional amplification kP of the difference controller 23 and also the reset time TN of the casting level controller 18 may be increased. In this last-mentioned case, it is possible for the increase in the proportional amplification kP of the difference controller 23 and the increase in the reset time TN of the casting level controller 18 to take place in the same time frame. It is however alternatively possible to perform an increase in the time frames which differ from one another, wherein if necessary an overlap range can be provided.

With the control method as disclosed herein, the interference compensator 20 may largely assume the determination of the stationary target setting p* of the closing facility 4. The interference compensator 20 may simultaneously operate in a more dynamically favorable manner than the integral contribution of the casting level controller 18. The reset time TN of the casting level controller 18 selected can therefore be greater, because the integral contribution only has to balance out minor inaccuracies. In individual cases, the integral portion can even be omitted completely (reset time Tn against infinite). With the control method disclosed herein, it is possible to respond considerably more effectively to sudden interferences when feeding liquid metal 3 into the continuous casting mold 1 and when drawing the metal strand 7 from the continuous casting mold 1 and the casting level 9 is thus kept constant in an improved fashion.

What is claimed is:

1. A control method for the casting level of a continuous casting mold, comprising:
adjusting an inflow of liquid metal into the continuous casting mold using a closing facility and drawing a partially solidified metal strand out of the continuous casting mold using a draw facility,
feeding a measured actual value of the casting level to a casting level controller, which determines a target setting based on the actual value and a corresponding target value and feeds the target setting to the closing facility,
feeding the measured actual value and an actual setting of the closing facility to an interference compensator,
determining an expected value for the casting level at the interference compensator and subtracting the expected value from the measured actual value of the casting level to determine a difference,
feeding the difference to a difference controller, which determines a controller output signal based on the difference,
multiplying the controller output signal by a superposition factor and superimposing the result onto the target setting as an interference compensation value, and
superimposing an inflow signal derived from the actual setting onto the controller output signal and feeding the result to an integrator that generates an output signal that corresponds to the expected value for the casting level.

2. The control method of claim 1, wherein the expected value for the casting level is subtracted from the measured actual value of the casting level in an undelayed fashion.

3. The control method of claim 1, wherein the superposition factor comprises an initial value at the start of the control method and is continuously increased to a final value during the course of the control method.

4. The control method of claim 3, wherein the initial value of the superposition factor is zero and the final value of the superposition factor is one.

5. The control method claim 3, wherein the casting level controller is embodied as a controller with integral response and that a reset time of the casting level controller is increased from an initial value to a final value during and/or after increasing the superposition factor.

6. The control method of claim 5, wherein the final value of the reset time is infinite.

7. The control method of claim 3, wherein the difference controller comprises a proportional amplification and that the proportional amplification is increased from an initial value to a final value during and/or after increasing the superposition factor.

8. The control method of claim 7, wherein the initial value of the proportional amplification of the difference controller is equal to a proportional amplification of the casting level controller.

9. The control method of claim 1, wherein the difference controller is embodied as a pure P-controller.

10. A computer program including a machine code stored in non-transitory computer-readable media, which can be executed by a control facility for a continuous casting system and the execution of which by the control facility causes the control facility to control the casting level of a continuous casting mold of the continuous casting system by:
adjusting an inflow of liquid metal into the continuous casting mold using a closing facility and drawing a partially solidified metal strand out of the continuous casting mold using a draw facility,
feeding a measured actual value of the casting level to a casting level controller, which determines a target setting based on the actual value and a corresponding target value and feeds the target setting to the closing facility,
feeding the measured actual value and an actual setting of the closing facility to an interference compensator,
determining an expected value for the casting level at the interference compensator and subtracting the expected value from the measured actual value of the casting level to determine a difference,
feeding the difference to a difference controller, which determines a controller output signal based on the difference,
multiplying the controller output signal by a superposition factor and superimposing the result onto the target setting as an interference compensation value, and
superimposing an inflow signal derived from the actual setting onto the controller output signal and feeding the result to an integrator that generates an output signal that corresponds to the expected value for the casting level.

11. The computer program of claim 10, wherein the computer program is stored on a data carrier.

12. The computer program of claim 11, wherein the data carrier is a component of the control facility.

13. (canceled)

14. A continuous casting system, comprising:
a control facility including a control system that controls the casting level of a continuous casting mold by:
adjusting an inflow of liquid metal into the continuous casting mold using a closing facility and drawing a partially solidified metal strand out of the continuous casting mold using a draw facility,
feeding a measured actual value of the casting level to a casting level controller, which determines a target setting based on the actual value and a corresponding target value and feeds the target setting to the closing facility,
feeding the measured actual value and an actual setting of the closing facility to an interference compensator,
determining an expected value for the casting level at the interference compensator and subtracting the expected value from the measured actual value of the casting level to determine a difference,
feeding the difference to a difference controller, which determines a controller output signal based on the difference,
multiplying the controller output signal by a superposition factor and superimposing the result onto the target setting as an interference compensation value, and
superimposing an inflow signal derived from the actual setting onto the controller output signal and feeding the result to an integrator that generates an output signal that corresponds to the expected value for the casting level.

15. The computer program of claim 10, wherein the expected value for the casting level is subtracted from the measured actual value of the casting level in an undelayed fashion.

16. The computer program of claim 10, wherein the superposition factor comprises an initial value at the start of the control method and is continuously increased to a final value during the course of the control method.

17. The computer program of claim 16, wherein the initial value of the superposition factor is zero and the final value of the superposition factor is one.

18. The computer program of claim 16, wherein the casting level controller is embodied as a controller with integral response and that a reset time of the casting level controller is increased from an initial value to a final value during and/or after increasing the superposition factor.

19. The computer program of claim 16, wherein the difference controller comprises a proportional amplification and that the proportional amplification is increased from an initial value to a final value during and/or after increasing the superposition factor.

20. The computer program of claim 19, wherein the initial value of the proportional amplification of the difference controller is equal to a proportional amplification of the casting level controller.
